(19) United States
(12) Patent Application Publication
(10) Pub. No.: US 2026/0064180 A1
(43) Pub. Date: Mar. 5, 2026

(54) ELECTRONIC DEVICE, METHOD, AND STORAGE MEDIUM FOR POWER CONSUMPTION CONTROL

(71) Applicant: Smarter Silicon (Shanghai) Technologies Co., Ltd., Shanghai (CN)

(72) Inventor: Ben DAI, Shanghai (CN)

(21) Appl. No.: 19/307,775

(22) Filed: Aug. 22, 2025

(30) Foreign Application Priority Data
Aug. 27, 2024 (CN) 202411186583.1

(51) Int. Cl. G06F 1/3206; G06F 1/3296

(52) U.S. Cl. CPC G06F 1/3206; G06F 1/3296

(57) ABSTRACT

An electronic device includes one or more processors and one or more memories storing a program that, when being executed, causes the one or more processors to: periodically detect an event parameter of a target event according to a prediction period, and store a predicted value of the event parameter corresponding to a next prediction period according to the event parameter, the target event being related to a target component to be controlled; and periodically obtain the predicted value currently stored by the prediction unit according to a control period, and control a power consumption parameter of the target component according to the predicted value in the current control period.

### CROSS-REFERENCE TO RELATED APPLICATION

The present disclosure claims priority to Chinese Patent Application No. 202411186583.1 filed on Aug. 27, 2024, the entire content of which is incorporated herein by reference.

### FIELD OF TECHNOLOGY

The present disclosure relates to the power consumption control technology field and, more particularly, to a power consumption controller and a power consumption control method.

### BACKGROUND

An electronic device generally includes a plurality of modules/components with different functions, e.g., a high-speed cache module configured to provide high-speed cache. To reduce power consumption, some electronic devices are provided with specific power consumption control software. An application scenario of the device is recognized through power consumption control software to adjust the power consumption of a corresponding module based on the application scenario.

The problem is that the software needs to adjust the power consumption based on the application scenario of the electronic device over a relatively long time window (e.g., 5 minutes or 10 minutes), which results in a long time window for software adjustment. Thus, timeliness is poor, and the power consumption cannot be controlled according to the needs of various modules of the electronic device.

### SUMMARY

One embodiment of the present disclosure provides an electronic device. The electronic device includes one or more processors; and one or more memories storing a program that, when being executed, causes the one or more processors to: periodically detect an event parameter of a target event according to a prediction period, and store a predicted value of the event parameter corresponding to a next prediction period according to the event parameter, the target event being related to a target component to be controlled; and periodically obtain the predicted value currently stored by the prediction unit according to a control period, and control a power consumption parameter of the target component according to the predicted value in the current control period.

Another embodiment of the present disclosure provides a power consumption control method. The method includes periodically detecting an event parameter of a target event according to a prediction period, storing a predicted value of the event parameter corresponding to a next prediction period according to the event parameter, periodically obtaining the predicted value currently stored by the prediction unit according to a control period, and controlling a power consumption parameter of the target component according to the predicted value in the current control period. The target event is related to a target component to be controlled.

Another embodiment of the present disclosure provides a non-transitory computer readable storage medium, containing a program that, when being executed, causes at least one processor to: periodically detect an event parameter of a target event according to a prediction period, and store a predicted value of the event parameter corresponding to a next prediction period according to the event parameter, the target event being related to a target component to be controlled; and periodically obtain the predicted value currently stored by the prediction unit according to a control period, and control a power consumption parameter of the target component according to the predicted value in the current control period.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic structural diagram of a power consumption controller according to some embodiments of the present disclosure.

FIG. 2 is a schematic structural diagram of another power consumption controller according to some embodiments of the present disclosure.

FIG. 3 is a schematic structural diagram of another power consumption controller according to some embodiments of the present disclosure.

FIG. 4 is a schematic structural diagram of an electronic device according to some embodiments of the present disclosure.

FIG. 5 is a schematic flowchart of a power consumption control method according to some embodiments of the present disclosure.

### DETAILED DESCRIPTION

The technical solutions of embodiments of the present disclosure are described in detail in connection with the accompanying drawings of embodiments of the present disclosure. Obviously, the described embodiments are merely some embodiments of the present disclosure and not all embodiments. Based on embodiments of the present disclosure, all other embodiments obtained by those of ordinary skill in the art without creative efforts shall fall within the scope of the present disclosure.

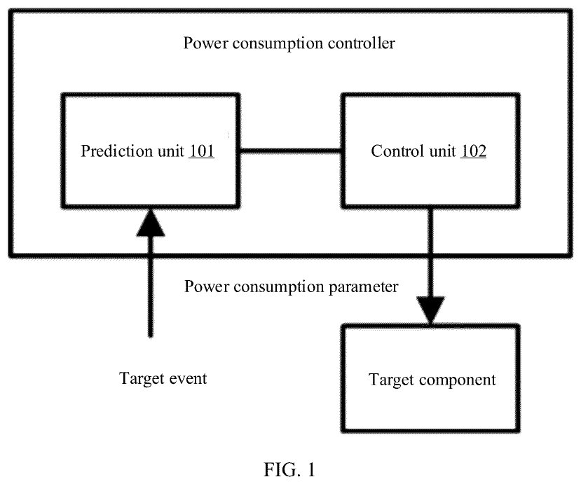

Embodiments of the present disclosure provide a power consumption controller. As shown in FIG. 1, the module includes a prediction unit 101 and a control unit 102.

The prediction unit 101 can be configured to periodically detect an event parameter of a target event according to a prediction period and to store a predicted value of the corresponding event parameter within a next prediction period according to the event parameter. The target event is related to a target component to be controlled.

The control unit 102 can be configured to periodically obtain the predicted value currently stored by the prediction unit according to a control period and to control a power consumption parameter of the target component in the current control period according to the predicted value.

The target component can be any module that requires power consumption control during the operation of the electronic device, e.g., a processor module, a cache module configured to provide high-speed cache, or a network module configured to connect to a network, etc.

The target event can be any event related to the target component that is generated during the operation of the target component. With different target components, different events can be determined as target events.

For example, when the target component is a cache module, the target event can be an event in which other modules of the electronic device access the cache module. That is, each time the cache module is accessed, a target event can be triggered. The event triggered by the cache module can be a performance monitor unit (PMU) event.

The target event can be reported by the target component to the prediction unit. Taking the cache module as an example, each time the cache module is accessed, a target event can be reported to the prediction unit.

The method for the target component to report an event can include the target component sending a signal indicating the target event to the prediction unit. Each time the prediction unit detects the signal, the target event can be detected once.

The event parameter of the target event can be a number of detected target events, an occurrence frequency of the detected target events, or other parameters related to the target event, which is not limited.

The prediction period can be used to control the frequency at which the prediction unit predicts the event parameters. In some embodiments, the prediction period can be denoted as S1. The specific duration of the prediction period can be set as needed and is not limited, e.g., 1 second, 100 milliseconds, etc.

In some embodiments, the prediction period can be set according to the required prediction accuracy. When the set prediction period is shorter, the prediction accuracy can be higher, and the predicted value obtained by the prediction unit can be closer to the actual event parameter of the target event in the next prediction period.

According to different data that need to be processed by the electronic device, the event parameter of the target event can have different values in different prediction periods. For example, when the event parameter of the target event is the number of the target events, in the i-th prediction periods after the power consumption controller starts, the number of detected target events can be 20, in the (i+1)-th prediction period, the detected number can be 30, and in the (i+2)-th prediction period, the detected number can be 15, i being any positive integer.

The number of target events can be counted by a counter. The prediction unit can directly read the value of the counter to obtain the parameter. The counter can be cleared at the end of each prediction period to start counting the number of target events again.

The predicted value of the corresponding event parameter in the next prediction period can be equivalent to the possible value of the event parameter in the next prediction period predicted by the prediction unit. For example, when the event parameter of the target event is the number of the target events, the predicted value of the corresponding event parameter in the next prediction period can be 40, which indicates that the prediction unit predicts that 40 target events can be detected in the next prediction period.

After the power consumption controller starts, the prediction unit 101 can continuously detect the event parameter of the target event, and at the end of each prediction period, within time far shorter than the prediction period (e.g., within 100 clock cycles), the predicted value of the corresponding event parameter for the next prediction period can be determined according to the detected event parameter, and the determined predicted value can be stored, for example, in a specific register.

For example, at the end of the first prediction period, the prediction unit can determine and store the predicted value of the second prediction period according to the event parameter detected in the first prediction period. At the end of the second prediction period, the prediction unit can determine and store the predicted value for the third prediction period according to the event parameter detected during the second prediction period, and so on.

The control period can be used to indicate the frequency at which the control unit performs power consumption control. In some embodiments, the control period can be denoted as S2. The control period and the prediction period can be two independent periods. That is, the length of the control period and the length of the prediction period can be unrelated. The specific duration of the control period can also be set as needed and is not limited, e.g., 200 seconds, 500 milliseconds, etc.

The prediction period and the control period can be two independent periods. The prediction period can be adjusted according to the required prediction accuracy, and the control period can be adjusted according to the required control accuracy.

When the control period is shorter, the control unit 102 can more frequently control the power consumption parameter of the target component to obtain better performance in power consumption reduction for the target component.

When the prediction period is shorter, the predicted value obtained by the prediction unit 101 can be more accurate.

Therefore, setting a shorter prediction period and a shorter control period can be beneficial for the power consumption controller to detect changes in the operation status of the target component in time and timely adjust the power consumption parameter according to the change in operation status.

The control unit can, within a period significantly shorter than the control period (e.g., within 100 clock cycles) at the beginning of each control period, read the current predicted value stored in the register of the prediction unit, and then configure the power consumption parameter of the target component in this control period according to the read predicted value. Thus, the target component can operate according to the configured power consumption parameter in this control period.

If the control unit does not read the predicted value from the register of the prediction unit, the power consumption parameter may not be configured according to the predicted value. Then, the target component can continue to operate with the power consumption parameter from the previous control period.

For example, at the beginning of the first control period, the control unit can read a current predicted value stored by the prediction unit and configure the value of the power consumption parameter of the target component to x1 according to the current predicted value. Then, the target component can operate according to the power consumption parameter x1 in the first control period. At the beginning of the second control period, the control unit can read a current predicted value stored by the prediction unit and configure the value of the power consumption parameter of the target component to x2. Then, the target component can operate with the power consumption parameter x2 in the second control period, and so on.

The power consumption controller of embodiments of the present disclosure can be composed of physical components of the electronic device, such as registers, adders, multipliers, processors, etc.

The beneficial effects of this solution can include that the power consumption controller can directly predict the predicted value of the event parameter within a future period according to the detected event parameter of the target event to periodically control the power consumption parameter of the target component using the predicted value. Compared with the solution in the related technology that detects the application scenario, the event parameter of the target event can be obtained through hardware circuits. Thus, the time window for detecting the event parameter of the target event can be shorter. For example, the event parameter can be detected within 1 second or 100 milliseconds. Furthermore, the power consumption controller can control the power consumption parameter of the target component through the hardware circuits. Therefore, the present solution can provide better timeliness in adjusting the power consumption of the target component and can dynamically control the power consumption parameter of the target component in real time according to the fluctuation in the operation of the electronic device.

On another hand, compared with a software-detected application scenario, the target event related to the target component can more directly reflect the demand of the electronic device for the target component. Therefore, controlling the power consumption according to the event parameter of the target event can allow the power consumption parameter of the target component to better match the actual operation requirement, and reduce the situation where the configured power consumption parameter is too low or too high.

In some embodiments, a plurality of target components can be provided. Each target component can correspond to one prediction unit and one control unit.

That is, the power consumption controller of embodiments of the present disclosure can be configured to control the power consumption parameters of the plurality of target components.

When the plurality of target components are provided, the power consumption controller can include a corresponding number of prediction units and a corresponding number of control units. Each target component can correspond to a dedicated prediction unit and a dedicated control unit. The power consumption parameter of the target component can be independently controlled by the corresponding prediction unit and control unit.

The target event detected by each prediction unit can be related to the target component corresponding to the prediction unit.

Each control unit can control the power consumption parameter of the corresponding target component according to the predicted value output by the prediction unit corresponding to the same target component.

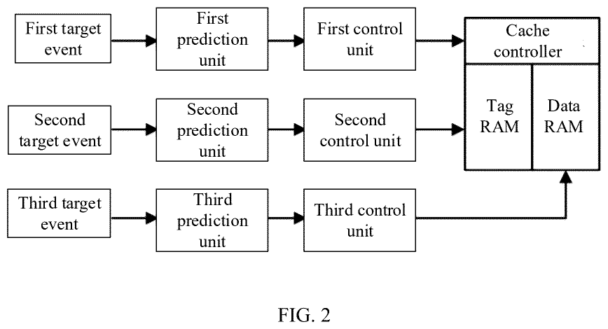

For example, as shown in FIG. 2, the target component to be controlled includes a Tag RAM, a Data RAM, and a Cache Controller that form the cache.

The cache controller can correspond to the first prediction unit and the first control unit.

The Tag RAM can correspond to the second prediction unit and the second control unit.

The Data RAM can correspond to the third prediction unit and the third control unit.

When the power consumption controller is in operation, the first prediction unit can detect a first target event related to the cache controller and store the predicted value of the event parameter of the first target event in the next prediction period. The first control unit can control the power consumption parameter of the cache controller in the current control period according to the predicted value corresponding to the first target event.

The second prediction unit can detect a second target event related to the Tag RAM and store the predicted value of the event parameter of the second target event for the next prediction period. The second control unit can control the power consumption parameter of the Tag RAM in the current control period according to the predicted value corresponding to the second target event.

The third prediction unit can detect a third target event related to the Data RAM and store the predicted value of the event parameter of the third target event for the next prediction period. The third control unit can control the power consumption parameter of the Data RAM in the current control period according to the predicted value corresponding to the third target event.

For example, the first target event can be an event where another module of the electronic device accesses the cache controller. The second target event can be an event where another module of the electronic device accesses the Tag RAM. The third target event can be an event where another module of the electronic device reads data from or writes data to the Data RAM.

The beneficial effect of embodiments of the present disclosure can include that the power consumption parameter of each target component can be independently controlled by the plurality of prediction units and the plurality of control units. On one hand, the timeliness of regulating the power consumption parameter of the target component can be improved to avoid a long delay caused by when a plurality of target components need to be regulated. On another hand, interference between the regulation processes of different target components can be avoided to cause a large deviation between the regulation result and the actual situation.

In some embodiments, the control unit can control the power consumption parameter of the target component by determining a power consumption parameter level corresponding to the predicted value and in the current control period, setting the value of the power consumption parameter of the target component to the value corresponding to the power consumption parameter level.

In some embodiments, the control unit 102 can include one or more memories. The memory can store a threshold table for determining the power consumption parameter level and a configuration table for setting the value of the power consumption parameter.

The threshold table can include a plurality of power consumption parameter levels and the threshold corresponding to each power consumption parameter level. When the power consumption parameter level is higher, the threshold can be larger. For example, the threshold table can include n power consumption parameter levels, level 1 corresponding to threshold T1, level 2 corresponding to threshold T2, level 3 corresponding to threshold T3, . . . level n corresponding to threshold Tn, where T1 through Tn increase monotonically.

When the power consumption parameter level corresponding to the predicted value is determined, the control unit can traverse each power consumption parameter level from level 1 in the threshold table. For each power consumption parameter level, the control unit can compare the threshold corresponding to the power consumption parameter level, the threshold corresponding to the next power consumption parameter level of the power consumption parameter level, and the currently obtained predicted value. For any level x between level 1 to level n, if the currently obtained predicted value satisfies the predicted value being greater than or equal to the threshold Tx corresponding to the power consumption parameter level x and smaller than the threshold Tx+1 of the next power consumption parameter level x+1, the power consumption parameter level corresponding to the predicted value can be determined as x.

For example, if the predicted value is greater than or equal to threshold T2 corresponding to level 2 and less than the threshold T3 corresponding to the next level, the power consumption parameter level corresponding to the predicted value can be determined as level 2.

The configuration table can record the value of the power consumption parameter corresponding to each power consumption parameter level. When the level is higher, the corresponding value can be larger. After the level corresponding to the predicted value is determined, the control unit can find the value corresponding to the level from the configuration table and set the value of the power consumption parameter of the target component to the found value to complete the control of the power consumption parameter for the current control period.

For different target components, the control unit corresponding to the target component can control one or a plurality of different power consumption parameters of the target component.

As shown in FIG. 2, if the target component is the cache controller, the power consumption parameter of the target component controlled by the first control unit can be an operation frequency of the cache controller.

Then, the configuration table of the first control unit can record a plurality of power consumption parameter levels and the frequency value (i.e., frequency point) corresponding to each level. When the level is higher, the frequency value can be larger. For example, level 1 can correspond to frequency point 1, level 2 can correspond to frequency point 2, and level 3 can correspond to frequency point 3, where frequency point 1 can be smaller than frequency point 2, and frequency point 2 can be smaller than frequency point 3.

Assume that at the beginning of the current control period, the first control unit determines that the predicted value corresponds to level 2, the first control unit can set the operation frequency of the cache controller to frequency point 2. Thus, in the current control period, the cache controller can operate at the operation frequency corresponding to frequency point 2.

As shown in FIG. 2, if the target component is the Data RAM, the power consumption parameter of the target component controlled by the third control unit includes an operation frequency and a number of operation partitions of the Data RAM.

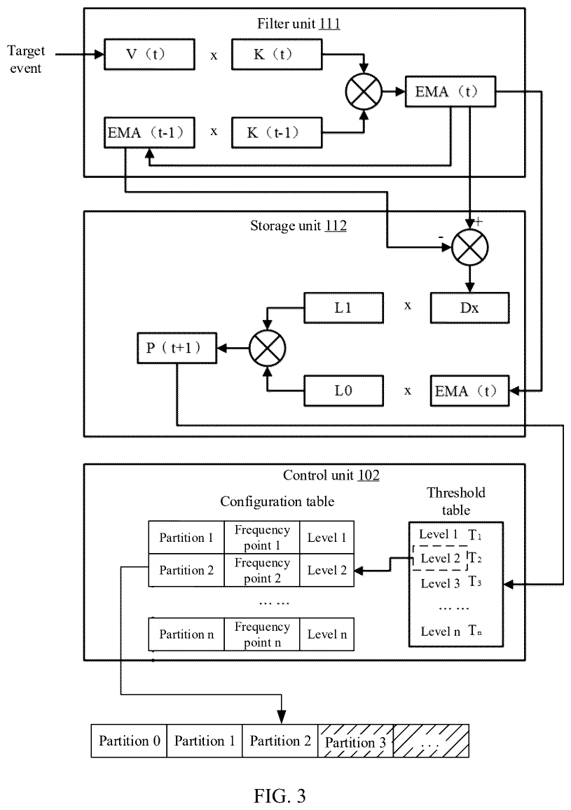

The Data RAM can include a plurality of consecutive partitions (i.e., ways) for storage. For example, as shown in FIG. 3, the Data RAM includes partition 0, partition 1, partition 2, partition 3, and so on.

When the third control unit controls the power consumption parameter of the Data RAM, on one hand, the operation frequency of the Data RAM can be set to the frequency point corresponding to the power consumption parameter level. On another hand, the Data RAM can be controlled to enable how many partitions of the Data RAM in the current control period according to the power consumption parameter level.

As shown in FIG. 3, after the third control unit determines that the currently read predicted value corresponds to power consumption parameter level 2, frequency point 2 and partition 2 corresponding to level 2 are found in the configuration table. Then, the operation frequency of the Data RAM is set to frequency point 2 and partition 2 and the previous partitions of the Data RAM are controlled to be in the enabled state (i.e., powered-on state), and the partitions after partition 2 are in the disabled state (i.e., powered-off state). That is, partitions 0, 1, and 2 are in the powered-on state, and partitions 3 and subsequent partitions 4, 5, etc., are in the powered-off state.

Correspondingly, at the beginning of the next control period, if the predicted value read by the third control unit corresponds to level 3, the third control unit, in the next control period, can control the Data RAM to operate at frequency point 3 corresponding to level 3, and control partitions 0 to 3 to be powered on, and partitions 4 and subsequent partitions to be powered off.

If the target component is the Tag RAM, the power consumption parameters of the target component controlled by the second control unit can include the operation frequency and the number of operating partitions of the Tag RAM. The control method of the second control unit can be the same as the control method of the third control unit, which is not repeated here.

By setting different power consumption parameter levels corresponding to different predicted values and the values of the power consumption parameters corresponding to different levels, the control unit can quickly configure the power consumption parameter of the target component at the beginning of each control period according to the obtained predicted value to improve the timeliness of power consumption control.

The prediction unit can determine the predicted value of the next prediction period in various methods.

In some embodiments, the prediction unit can determine the change trend of the event parameter according to the event parameters detected in the most recent two or more prediction periods and determine the predicted value for the next prediction period according to the change trend and the event parameter detected in the current prediction period.

In other embodiments, the prediction unit can also include a filter unit 111 and a storage unit 112, and determine the predicted value of the next prediction period based on the filter unit 111 and the storage unit 112.

The filter unit 111 can be configured to determine an exponential moving average of the current prediction period according to the event parameter.

The storage unit 112 can be configured to store the predicted value for the next prediction period according to the exponential moving average of the current prediction period and an exponential moving average of the previous prediction period.

The exponential moving average (EMA) of the current prediction period can be determined according to the event parameter detected in the current prediction period and the exponential moving average value of the previous prediction period.

As shown in FIG. 3, the current prediction period is the t-th prediction period after the power consumption controller is activated (e.g., t being greater than or equal to 2), the predicted value of the next prediction period is determined by the prediction unit in the following method.

At the end of the t-th prediction period, the filter unit 111 reads event parameter V(t) of the target event detected in the t-th prediction period from the counter configured to count the event parameters. The filter unit 111 also obtains exponential moving average EMA(t−1) of the previous prediction period (i.e., the (t−1)-th prediction period) stored in a register at the end of the previous prediction period.

Then, the filter unit 111 calculates the exponential moving average EMA(t) of the current prediction period (i.e., the t-th prediction period) according to V(t) and EMA(t−1). The calculation method is expressed by the following formula (1):

$$V ( t ) * K ( t ) + EMA ( t - 1 ) * K ( t - 1 ) = EMA ( t ) \qquad ( 1 )$$

That is, the sum of the product of V(t) and K(t) and the product of EMA(t−1) and K(t−1) is the exponential moving average value EMA(t) of the current prediction period.

K(t) and K(t−1) are both preset weight coefficients stored in the filter unit 111, where K(t) is the first weight coefficient, and K(t−1) is the second weight coefficient. The sum of K(t) and K(t−1) equals 1. These two parameters affect the contribution ratio of the current value and the historical value to the exponential moving average of the current prediction period. If the predicted value is expected to reflect as much as possible the needs of the target component in the current prediction period, a larger K(t) can be set. If the predicted value is expected to reflect as much as possible the needs of the target component in the previous prediction period, a larger K(t−1) can be set.

After EMA(t) is obtained, the storage unit 112 can determine the change amplitude of the exponential moving average based on EMA(t−1) of the previous prediction period and the EMA(t) of the current prediction period, and then determine the predicted value of the next prediction period according to the change amplitude and the exponential moving average of the current prediction period.

In some embodiments, if the current prediction period is the first prediction period after the power consumption controller is started, the filter unit 111 can directly determine the event parameter of the current prediction period as the exponential moving average of the current prediction period, i.e., EMA(1)=V(1).

The predicted value of the next prediction period can be determined by the following formula (2):

$$P ( t + 1 ) = L 0 * EMA ( t ) + L 1 * Dx \qquad ( 2 )$$

The storage unit 112 can calculate the sum of the product of L0 and EMA(t) and the product of L1 and Dx as the predicted value of the next prediction period.

Dx represents the change amplitude of the exponential moving average and is determined by the following formula (3):

$$Dx = EMA ( t ) - EMA ( t - 1 ) \qquad ( 3 )$$

In formula (2), L0 and L1 are preset parameters. The values of L0 and L1 can affect the contribution ratio of the exponential moving average of the current prediction period and the change amplitude to the predicted value. When L0 is larger, the proportion of the exponential moving average of the current prediction period can be larger in the predicted value. When L1 is larger, the influence of the change amplitude can be larger in the predicted value. In some embodiments, L0 and L1 can both be set to 1.

If t=1, i.e., the current prediction period is the first prediction period after the power consumption controller is started, when the storage unit 112 determines the predicted value of the next prediction period, EMA(0) can be set to 0, or EMA(0) can be set equal to EMA(1).

When the predicted value is determined above, the predicted value of the next prediction period can be related to the EMA value of the current prediction period and the EMA value of the previous prediction period. The EMA value of each prediction period can be related to the event parameter of the prediction period and the EMA value of the previous prediction period. Therefore, the above method for determining the predicted value can comprehensively determine the predicted value of the next prediction period according to the event parameters of the current prediction period and the plurality of past prediction periods, which helps to determine a predicted value that better reflects the actual application condition of the target component in the next prediction period.

The filter unit 111 and the storage unit 112 can include several interconnected multipliers and adders. The above process of determining the predicted value can be implemented through the multipliers and adders. Compared with software-based methods, determining the predicted value using the multipliers and adders can achieve a faster computation speed.

In some embodiments, to reduce the hardware complexity of the filter unit 111, the multiplication operation when determining EMA(t) can be replaced with a shift operation. That is, a shifter can be configured to realize the multiplication operation when determining EMA(t). Thus, the method of the filter unit 111 determining EMA(t) can include performing shift processing on the event parameter detected during the current prediction period according to the first weight coefficient to obtain the first processing result, performing shift processing on the exponential moving average of the previous prediction period according to the second weight coefficient to obtain the second processing result, and determining the exponential moving average of the current prediction period according to the first processing result and the second processing result.

The first processing result above can be equivalent to the product V(t)*K(t) in formula (1), and the second processing result can be equivalent to the product EMA(t−1)*K(t−1) in formula (1).

The beneficial effect of determining EMA(t) above can include that the filter unit 111 can only need to perform shift processing on V(t) and EMA(t−1) stored in the corresponding registers to obtain the exponential moving average of the current prediction period, without configuring multipliers for performing the multiplication operation. Then, the hardware structure of the filter unit 111 can be simplified, and the hardware complexity of the filter unit 111 can be reduced.

In some embodiments, when L0 and L1 are not equal to 1, the storage unit 112 can also determine the predicted value of the next prediction period in the above manner through shift processing.

In some embodiments, when the storage unit 112 and the filter unit 111 perform the above operation, the storage unit 112 and the filter unit 111 can use a fixed-point operation to replace a floating-point operation to further reduce the hardware complexity of the storage unit 112 and the filter unit 111. For example, when the storage unit 112 determines the predicted value of the next prediction period, the storage unit 112 can perform the fixed-point operation based on formulas (2) and (3) above on the exponential moving average of the current prediction period and the exponential moving average of the previous prediction period to obtain the predicted value of the next prediction period.

In some embodiments, the prediction unit can include a statistical subunit. The statistical subunit can be configured to, in each prediction period, perform statistics in response to the target event generated by the target component to obtain the event parameter of the target event and, when each prediction period ends, restore the event parameter of the target event to the initial value.

The statistical subunit can include a counter.

The counter can be configured to increase the count by 1 each time the counter receives a signal representing the target event, and perform an initialization operation at the end of each prediction period to restore the count to the initial value. The initial value can be configured to 0.

Thus, the filter unit 111 can read the current count value of the statistical subunit at the end of each prediction period before the statistical subunit performs the initialization operation, and determine the read value as the event parameter of the target event within the current prediction period. The event parameter of the target event obtained in this manner can be equivalent to the number of times that the target event has cumulated in the target component in the current prediction period.

For example, at the end of the (t−1)-th prediction period, the filter unit 111 can obtain the event parameter of the (t−1)-th prediction period from the counter. Then, the counter can perform the initialization operation, and the count value of the counter can be reset to 0.

After entering the t-th prediction period, each time a target event occurs in the target component, a signal indicating the target event can be reported to the prediction unit. Each time the counter receives such a signal, the counter can increase the count value by 1. That is, after the initialization operation, when the signal is received for the first time, the count value can be increased from 0 to 1. When the signal is received for the second time, the count value can be increased from 1 to 2, and so on.

At the end of the t-th prediction period, the filter unit 111 can reads the current count value of the counter and determines the read value as the event parameter V(t) of the t-th prediction period, which indicates that V(t) times of the target events have occurred cumulatively in the target component in the t-th prediction period. Then, the counter can perform the initialization operation again and continue counting during the (t+1)-th prediction period.

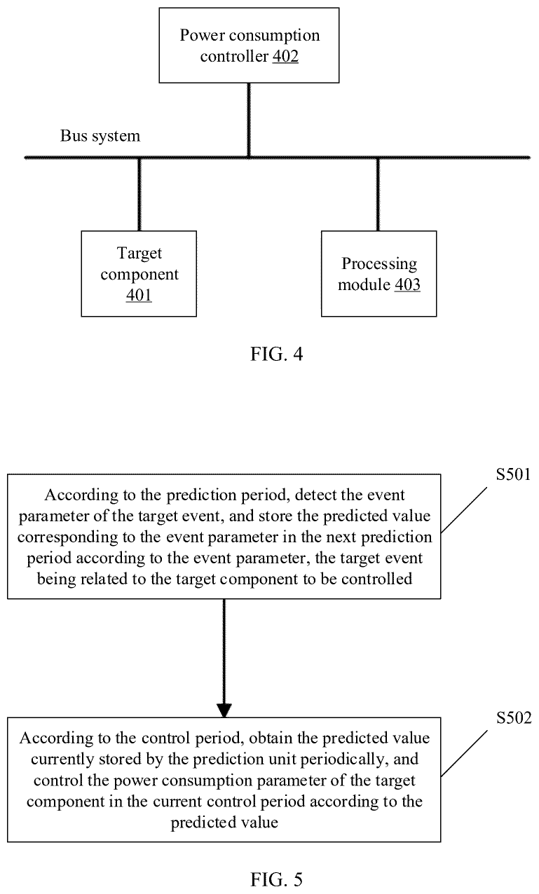

Embodiments of the present disclosure also provide an electronic device. As shown in FIG. 4, the electronic device includes a target component 401, a power controller 402, and a processor 403.

The target component 401 can be configured to cache the data required for the processor 403 to operate and the data output by the processor 403.

The processor 403 can read data from and write data to the target component 401 as needed.

The power consumption controller 402 can control the power consumption parameter of the target component 401 according to the control principle above to allow the power consumption parameter of the target component 401 to match the frequency for the target component 401 being read and written.

Embodiments of the present disclosure further provide a power consumption control method. As shown in FIG. 5, the method includes the following steps.

At S501, according to the prediction period, the event parameter of the target event is detected periodically, and the predicted value corresponding to the event parameter in the next prediction period is stored according to the event parameter. The target event is related to the target component to be controlled.

At S502, according to the control period, the predicted value currently stored by the prediction unit is periodically obtained, and the power consumption parameter of the target component is controlled in the current control period according to the predicted value.

For the implementation of the above control method, reference can be made to the operation principle of the power consumption controller above, which is not repeated here.

In some embodiments, the power consumption control method of embodiments of the present disclosure further includes configuring the prediction period and the control period according to the target component.

In some embodiments, the prediction period and the control period can be configured according to the changes in the event parameters of the target component in the plurality of past prediction periods. For example, if the event parameter of the target component fluctuates obviously in the past 10 prediction periods, e.g., event parameters of two prediction periods can be large, and event parameters of the subsequent two prediction periods can be small, the prediction period and the control period can be set to be short. Thus, as the event parameter fluctuates quickly, a suitable power consumption parameter can be configured for the target component high-efficiently.

If the event parameter of the target component does not fluctuate significantly over the past 10 prediction periods, e.g., the event parameters during five consecutive prediction periods are basically consistent, the prediction period and the control period can be set to be long to reduce the number of times the power controller that determines the predicted value and configures the power consumption parameters according to the above operation principle. Thus, the power consumption of the power controller can be lowered.

In some embodiments, the prediction period and control period can also be configured according to the power consumption of the target component. For example, if the average power of the target component is relatively high over a period of time, the prediction periods and the control period can be configured to be short. Then, by frequently controlling the power consumption parameter of the target component, unnecessary power consumption of the target component can be minimized during operation.

If the average power of the target component is relatively low over a period of time, the prediction period and the control period can be configured to be long, because a relatively low average power indicates that the target component is already in an overall low power consumption state. Even if the power parameters are frequently controlled, the amount of power that the target component can reduce can be limited, and the overall power consumption of the electronic device can be increased due to the frequent control of the power consumption parameter by the power controller. Therefore, the prediction period and the control period can be configured to be long to reduce the number of times the power controller determines the predicted values and controls the power consumption parameters.

Embodiments of the present disclosure are described in a progressive manner, and each embodiment focuses on the differences from the other embodiments. The same or similar parts among the various embodiments can be referred to each other.

To facilitate description, the system or apparatus above can be described as divided into various modules or units by function. Of course, when the present disclosure is implemented, the functions of the units can be realized in one or more pieces of software and/or hardware.

Through the above description of the embodiments, those skilled in the art can clearly understand that the present disclosure can be implemented by means of software plus a necessary general hardware platform. Based on such understanding, the technical solutions of the present disclosure, in essence, or the parts contributing to the relevant technology, can be embodied in the form of a software product. The computer software product can be stored in a storage medium, such as ROM/RAM, magnetic disk, optical disk, etc., and includes several instructions to make a computer device (e.g., a personal computer, server, or network device, etc.) execute the method described in embodiments or certain parts of embodiments of the present disclosure.

Finally, in the present presentation, the relational terms such as first, second, third, and fourth are merely used to distinguish one entity or operation from another entity or operation, and do not necessarily imply any actual relationship or order between these entities or operations. Furthermore, the terms “including,” “comprising,” or any other variations thereof are intended to cover non-exclusive inclusion, so that a process, method, article, or device that includes a set of elements not only includes those elements, but can also include other elements not expressly listed, or further include elements inherent to such process, method, article, or device. Without more limitations, an element defined by the phrase “including a . . . ” does not exclude the existence of other identical elements in the process, method, article, or device that includes the element.

The above description is only some embodiments of the present disclosure. For those of ordinary skill in the art, various modifications and improvements can be made without departing from the principles of the present disclosure. These modifications and improvements should also be within the scope of the present disclosure.

What is claimed is:

1. An electronic device comprising:
one or more processors; and
one or more memories storing a program that, when being executed, causes the one or more processors to:
periodically detect an event parameter of a target event according to a prediction period, and store a predicted value of the event parameter corresponding to a next prediction period according to the event parameter, wherein the target event is related to a target component to be controlled; and
periodically obtain the predicted value currently stored by the prediction unit according to a control period, and control a power consumption parameter of the target component according to the predicted value in the current control period.

2. The electronic device according to claim 1, wherein the one or more processors are further configured to:
determine a power consumption parameter level corresponding to the predicted value; and
in the current control period, set a value of the power consumption parameter of the target component to a value corresponding to the power consumption parameter level.

3. The electronic device according to claim 1, wherein the one or more processors are further configured to:
determine an exponential moving average of the current prediction period according to the event parameter; and
store a predicted value of the next prediction period according to the exponential moving average of the current prediction period and an exponential moving average of the next prediction period.

4. The electronic device according to claim 3, wherein the one or more processors are further configured to:
determine the exponential moving average of the current prediction period according to the event parameter detected in the current prediction period and an exponential moving average of a previous prediction period.

5. The electronic device according to claim 4, wherein the one or more processors are further configured to:
perform shift processing on the event parameter detected in the current prediction period according to a first weight coefficient to obtain a first processing result;
perform shift processing on the exponential moving average of the previous prediction period according to a second weight coefficient to obtain a second processing result; and
determine the exponential moving average of the current prediction period according to the first processing result and the second processing result.

6. The electronic device according to claim 3, wherein the one or more processors are further configured to:
perform a fixed-point operation according to the exponential moving average of the current prediction period and the exponential moving average of the previous prediction period to store the predicted value of the next prediction period.

7. The electronic device according to claim 1, wherein:
the prediction unit includes a statistical subunit; and
the statistical subunit is configured to, in each prediction period, respond to the target event generated by the target component to perform statistics and obtain the event parameter of the target event, and restore the event parameter of the target event to an initial value when each prediction period ends.

8. The electronic device according to claim 1, further comprising:
a prediction unit and a control unit, wherein
the prediction unit is configured to periodically detect the event parameter of the target event and to store the predicted value of the event parameter; and
the control unit is configured to periodically obtain the predicted value, and control the power consumption parameter of the target component.

9. The electronic device according to claim 2, wherein:
a plurality of target components are provided, each target component corresponding to one prediction unit and one control unit;
a target event detected by each prediction unit is related to the target component corresponding to the prediction unit; and
each control unit controls the power consumption parameter of the corresponding target component according to the predicted value output by the prediction unit corresponding to the same target component.

10. A power consumption control method comprising:
periodically detecting an event parameter of a target event according to a prediction period, and storing a predicted value of the event parameter corresponding to a next prediction period according to the event parameter, wherein the target event is related to a target component to be controlled; and
periodically obtaining the predicted value currently stored by the prediction unit according to a control period, and controlling a power consumption parameter of the target component according to the predicted value in the current control period.

11. The method according to claim 10, further comprising:
configuring the prediction period and the control period according to the target component.

12. The method according to claim 10, further comprising:
controlling the power consumption parameter of the corresponding target component according to the predicted value output by the prediction unit corresponding to the same target component.

13. The method according to claim 10, wherein controlling the power consumption parameter of the target component according to the predicted value in the current control period includes:
determining a power consumption parameter level corresponding to the predicted value; and
in the current control period, setting a value of the power consumption parameter of the target component to a value corresponding to the power consumption parameter level.

14. The method according to claim 10, further comprising:
determining an exponential moving average of the current prediction period according to the event parameter; and
storing a predicted value of the next prediction period according to the exponential moving average of the current prediction period and an exponential moving average of the next prediction period.

15. The method according to claim 14, wherein determining the exponential moving average of the current prediction period according to the event parameter includes:
determining the exponential moving average of the current prediction period according to the event parameter detected in the current prediction period and an exponential moving average of a previous prediction period.

16. The method according to claim 15, wherein determining the exponential moving average of the current prediction period according to the event parameter detected in the current prediction period and the exponential moving average of the previous prediction period includes:
performing shift processing on the event parameter detected in the current prediction period according to a first weight coefficient to obtain a first processing result;
performing shift processing on the exponential moving average of the previous prediction period according to a second weight coefficient to obtain a second processing result; and
determining the exponential moving average of the current prediction period according to the first processing result and the second processing result.

17. The method according to claim 14, wherein storing the predicted value of the next prediction period according to the exponential moving average of the current prediction period and the exponential moving average of the previous prediction period includes:
performing a fixed-point operation according to the exponential moving average of the current prediction period and the exponential moving average of the previous prediction period to store the predicted value of the next prediction period.

18. The method according to claim 10, further comprising:
in each prediction period, responding to the target event generated by the target component to perform statistics and obtain the event parameter of the target event; and
restoring the event parameter of the target event to an initial value when each prediction period ends.

19. A non-transitory computer readable storage medium, containing a program that, when being executed, causes at least one processor to:
periodically detect an event parameter of a target event according to a prediction period, and store a predicted value of the event parameter corresponding to a next prediction period according to the event parameter, wherein the target event is related to a target component to be controlled; and
periodically obtain the predicted value currently stored by the prediction unit according to a control period, and control a power consumption parameter of the target component according to the predicted value in the current control period.

20. The storage medium according to claim 19, wherein the at least one processor is further configured to:
determine a power consumption parameter level corresponding to the predicted value; and
in the current control period, set a value of the power consumption parameter of the target component to a value corresponding to the power consumption parameter level.
